(19) United States
(12) Patent Application Publication
(10) Pub. No.: US 2006/0092135 A1
(43) Pub. Date: May 4, 2006

(54) Wheel type mechanical instruction switch

(76) Inventors: Chin-Wen Chou, Taipei Hsien (TW); King-Long Lee, Taipei Hsien (TW)

Correspondence Address: BIRCH STEWART KOLASCH & BIRCH, PO BOX 747, FALLS CHURCH, VA, 22040-0747, US

(21) Appl. No.: 10/976,830

(22) Filed: Nov. 1, 2004

(51) Int. Cl. G09G 5/08

(52) U.S. Cl. 345/163

(57) ABSTRACT

A wheel type mechanical instruction switch adopts a low cost and simple terminal design to generate instructions to replace conventional electronic switches that are costly and complicated. The instruction switch is located between a wheel and a bracing seat. The instruction switch includes a connection terminal which has a first fastening end on one end to be fastened to the bracing seat and an operation end on other end extended to where an axle is located to generate a displacement, and a conductive terminal which has a second fastening end to be fastened to the bracing seat and a conductive end on other end extended to the displacement range of the connection terminal so that when the wheel receives a force and generate a wheel displacement, the axle drives the operation end to connect the conductive end to generate an instruction signal.

### FIELD OF THE INVENTION

The present invention relates to a wheel type mechanical instruction switch and particularly to a mechanical switch adopted for use on a wheel on electronic devices such as mouses, remote control devices or keyboards to output different instruction signals.

### BACKGROUND OF THE INVENTION

In the scroll mouse now being commonly used, there is a wheel located between the left and the right keys to enable users to directly skip pages or text lines through rotation of the wheel when reading lengthy texts (such as novels or presentation data) without depressing the page down key on the keyboard or moving the mouse and cursor to the scroll bar on the right side of the screen and depress the left key to execute page down or line skip operation. Namely, the wheel can replace the scroll bar function on the right side of the screen to make user operation easier.

In R.O.C. patent No. 590292, Applicant proposes an improved mouse design. It provides an improved scroll bar function on the screen that not only has a longitudinal up and down movement on the right side, also has a scroll bar design on the lower side of the screen to provide leftward and rightward transverse movements. It is applicable to table listing software such as EXCEL or ACCESS or Web pages. However, for lengthy table fields, scroll bar operation and control cannot fully meet requirements. The general keyboard also does not have corresponding keys to provide transverse movement function. Users have to move the mouse to the scroll bar and depress the left key to operate. Such a design does not fully exploit the advantages of the wheel. Therefore the cited reference aims to provide a design that directly uses the wheel of the mouse, and the left and right keys, and left and right direction keys to output switch ON/OFF signals to move the mouse cursor to a desired location for execution or viewing without moving the mouse (referring to FIG. 1).

FIG. 2 shows another conventional design disclosed by Microsoft Co. It is a mouse equipped with a tilt wheel. The product includes a sway seat to couple with a wheel. The sway seat may be moved with the wheel to the left and right side to touch button switches located on two sides of the sway seat to output corresponding instructions. Adding the sway seat makes design and fabrication more complicated. And the size of the mouse cannot be shrunk because of the addition of the sway seat and the button switches. It is suitable only for large mouse products.

Based on the two cited references mentioned above, it is clear that the industry at present still mainly focuses on the button switches to generate output signals. The button switch is more expensive. Moreover, with the prevailing product trend that requests lean and light, adding the button switch is against this trend in terms of the mouse size. Hence at present only the medium and large mouses adopt such a design. It also cannot be adapted to the keyboard or remote control device that also has a wheel. Because the location to accommodate the wheel is even more constrained on the keyboard and remote control device. Therefore to develop a small size, low cost and easy to fabricate wheel and instruction switch is one of the main design focuses in the industry.

There are other examples such as U.S. Pat. No. 6,700,564 which achieves picture scrolling function on the screen through pressure sensing. It still adopts a photoelectric design. The cost is higher and the required space is larger. Thus it also does not coincide with the current trend that demands lean and light.

### SUMMARY OF THE INVENTION

Therefore the primary object of the present invention is to resolve the aforesaid disadvantages. The present invention aims to provide a low cost and easy to assemble mechanical terminal design to replace the conventional electronic switches that are expensive and complicated. The instruction switch according to the invention is located between a wheel and a bracing seat. The instruction switch includes a connection terminal which has a first fastening end on one end to be fastened to the bracing seat and an operation end on other end which is extended to where an axle is located and is driven by the axle to move for a displacement when the wheel is moved, and a conductive terminal which has a second fastening end on one end to be fastened to the bracing seat and a conductive end on other end extended to the displacement range of the connection terminal such that when the wheel is moved by a force, the axle drives the operation end of the connection terminal to connect the conductive end of the conductive terminal to generate instruction signals.

Another object of the invention is to provide a click sensing dock that has a boss located between the operation end of the connection terminal and the conductive end of the conductive terminal so that the operation end can pass over the boss to generate a click sense when users operate with forces.

Yet another object of the invention is to provide an instruction switch that has a wheel tiltable relative to the bracing seat when subject to a force to generate a swaying displacement to produce leftward and rightward instruction signals, and depressible up and down for a displacement relative to the bracing seat to produce a depressing instruction signal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional technique adopted on a mouse.

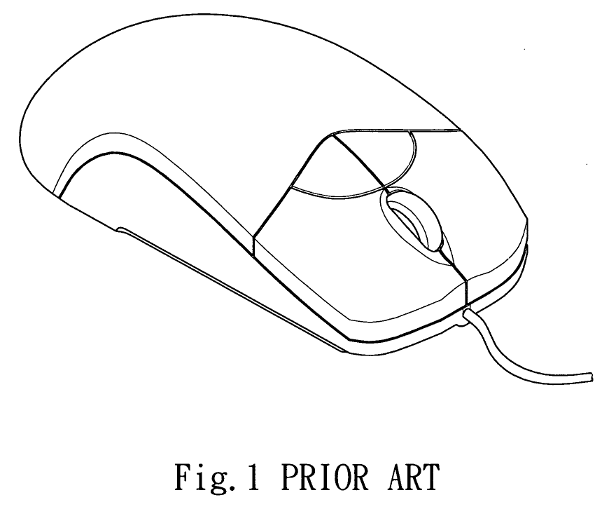

FIG. 2 is a perspective view of another conventional technique adopted on a mouse.

FIG. 3 is a perspective view of the invention.

FIG. 4 is an exploded view of the invention.

FIG. 5 is a fragmentary perspective view of the invention.

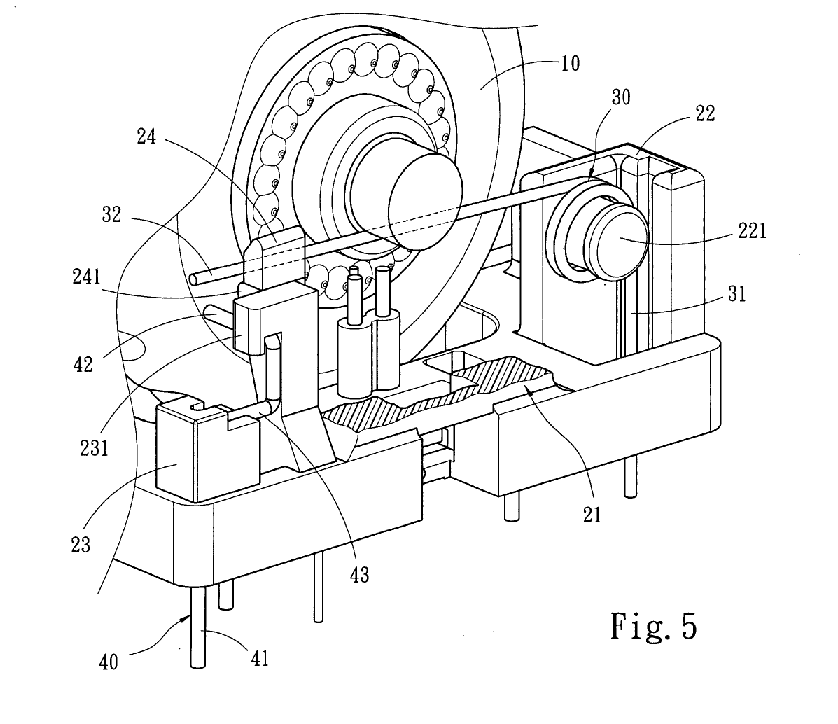

FIG. 6 is a sectional view of the invention.

FIG. 7 is a schematic view of the invention in a swaying condition.

FIGS. 8A and 8B are schematic views of the invention in depressing operations.

FIG. 9 is a schematic view of the invention adopted on a mouse.

FIG. 10 is a schematic view of the invention adopted on a keyboard.

### DETAILED DESCRIPTION OF THE PREFERRED EMBODIMENTS

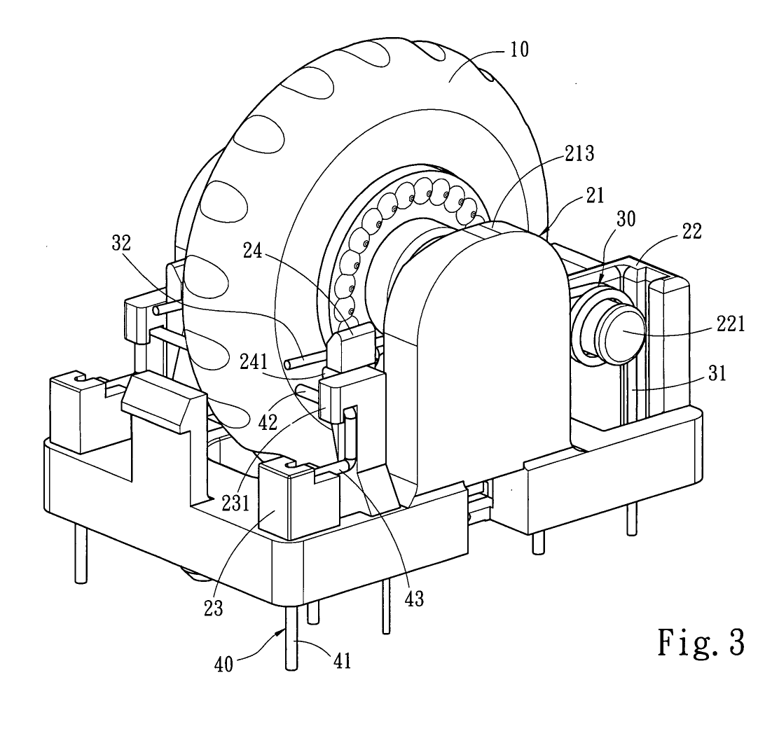

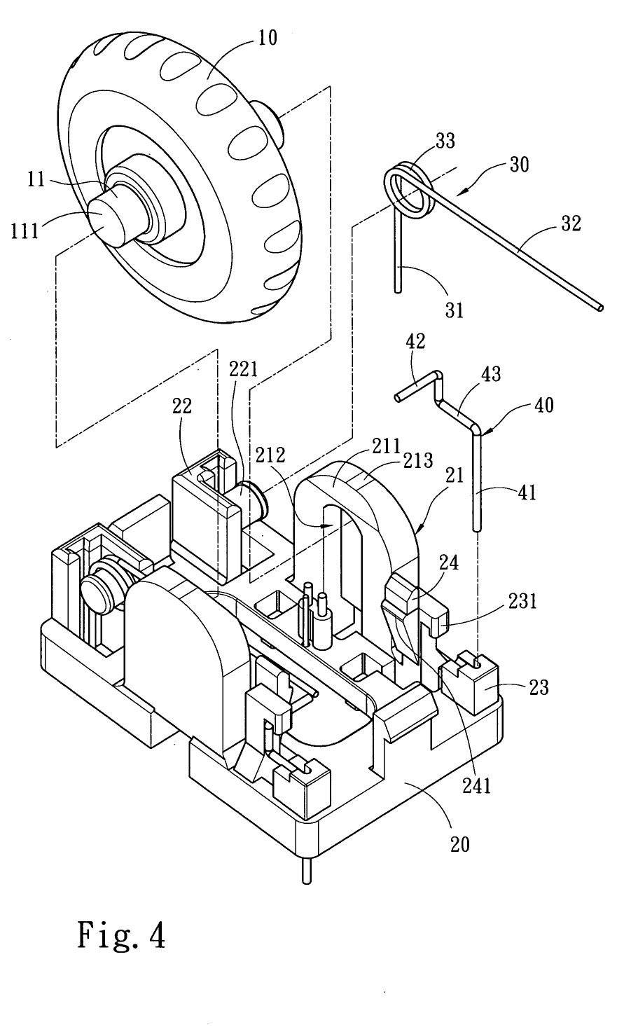

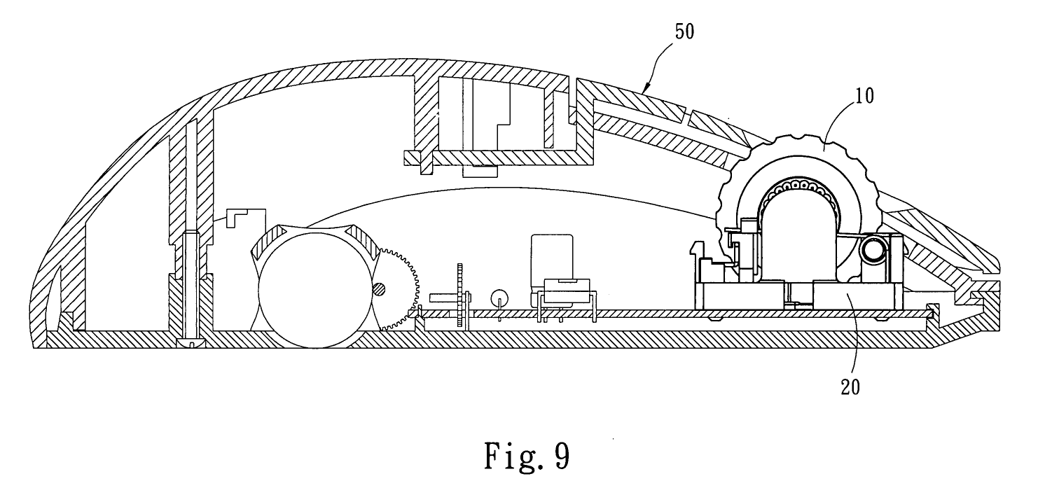

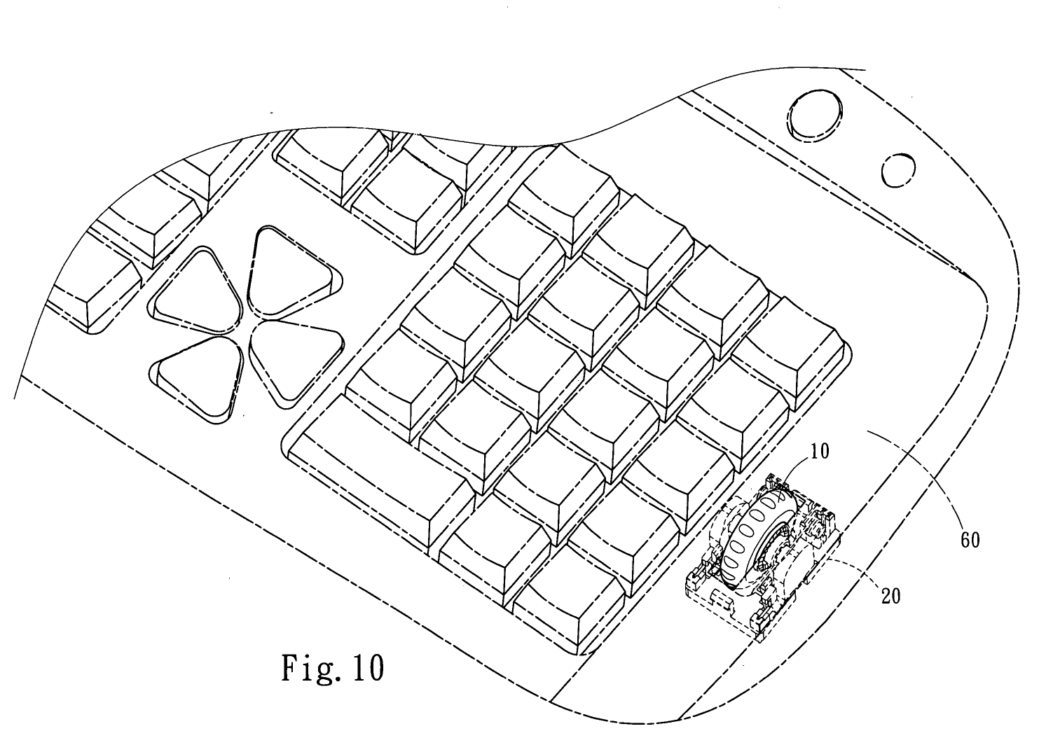

Please referring to FIGS. 3 and 4, the present invention is adopted for use on an electronic device such as a mouse 50 (as shown in FIG. 9) or a keyboard 60 (as shown in FIG. 10) to output different instruction signals. It includes a mechanical instruction switch located between a wheel 10 and a bracing seat 20 that corresponds to the swaying of the wheel 10 to generate the instruction signals.

The wheel 10 has an axle 11 in the center which has an arched end 111. The bracing seat 20 has a holding section 21 corresponding to the axle 11 that has an operation space 212 to hold the axle 11. The holding section 21 has a closed end 213 on the top to prevent the axle 11 from escaping. The operation space 212 has an inner wall formed in a flat surface or an arched surface mating the arched end 111. The holding section 21 further has a chamfered surface 211 on a upper end to facilitate insertion of the axle 11 into the operation space 212. The axle 11 is coupled on the holding section 21 such that the wheel 10 is movable up and down for a displacement on the bracing seat 20. The instruction switch includes a connection terminal 30 and a conductive terminal 40 located on one side or the left side and the right side of the wheel 10. The connection terminal 30 and the conductive terminal 40 have respectively a first fastening end 31 and a second fastening end 41 on one end to be fastened to a corresponding anchor section 22 and 23 on the bracing seat 20. The connection terminal 30 has an operation end 32 on other end extended to where the axle 11 is located to be depressed by the axle 11 when the wheel 10 is moved to generate a displacement. The connection terminal 30 has a middle portion wound to form an elastic coil 33 to give the operation end 32 a resilience desired. The operation end 32 is extended beneath the axle 11 to brace the wheel 10. The bracing seat 20 has a first bracing section 221 corresponding to and holding the elastic coil 33.

The conductive terminal 40 has a conductive end 42 on other end that is extended within the displacement range of the connection terminal 30. The conductive terminal 40 also has an elastic section 43 in the middle portion to be held on a corresponding second bracing section 231 formed on the bracing seat 20. In addition, the bracing seat 20 has a click sensing dock 24 with a boss 241 located between the operation end 32 of the connection terminal 30 and the conductive end 42 of the conductive terminal 40.

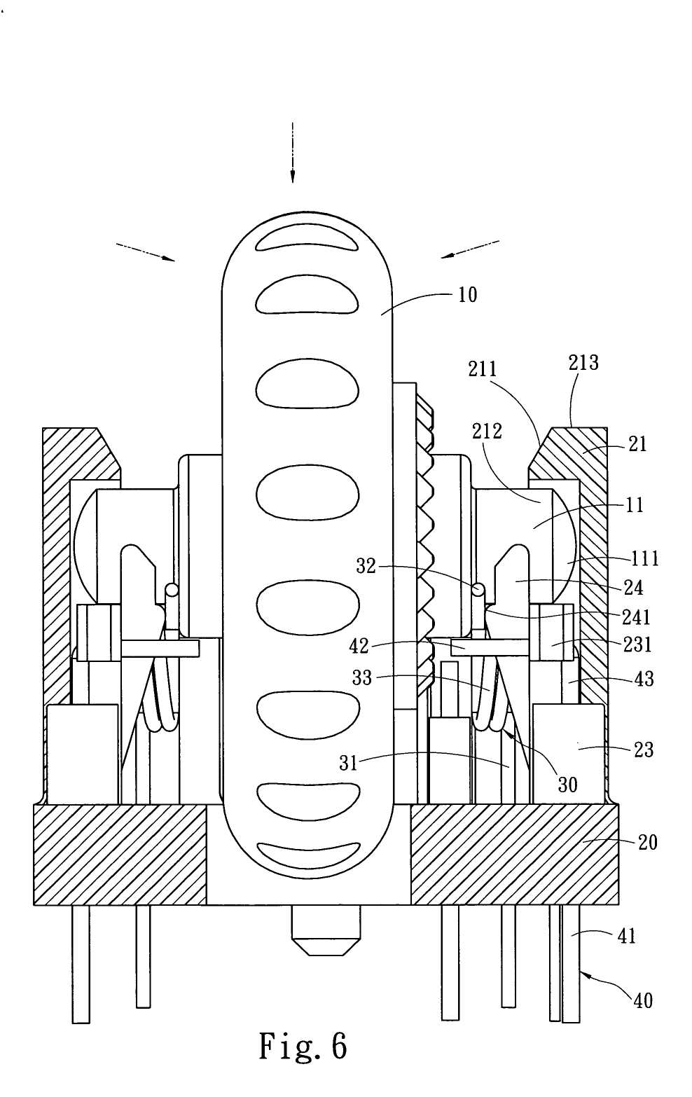

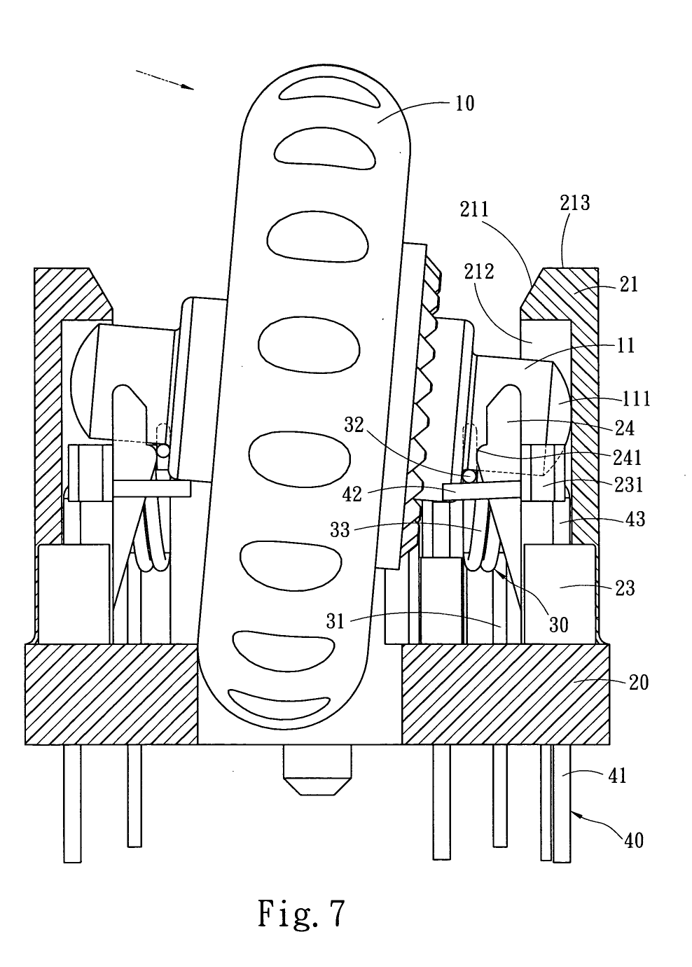

Referring to FIGS. 6 and 7, when a user exerts a force on the wheel 10 to tilt leftwards or rightwards relative to the bracing seat 20 to generate a swaying displacement, as the operation end 32 of the conductive terminal 30 has resilience due to the elastic coil 33, the axle 11 is moved by the swaying of the wheel 10 to compress the operation end 32 downwards. The operation end 32 slides over the boss 241 of the click sensing dock 24 to enable the user to feel a click sense. Meanwhile the operation end 32 connects the conductive end 42 of the conductive terminal 40 to generate a leftward or rightward instruction signal. When the force from the user is released, the resilience of the elastic coil 33 bounces the wheel 10 back to its original position, the closed end 213 of the holding section 21 prevents the axle 11 of the wheel 10 from escaping. In the event that the force exerted by the user to compress the conductive end 42 is too large, the elastic section 43 of the conductive terminal can provide a resilience on the conductive end 42 to help bouncing the wheel 10 back to its original position.

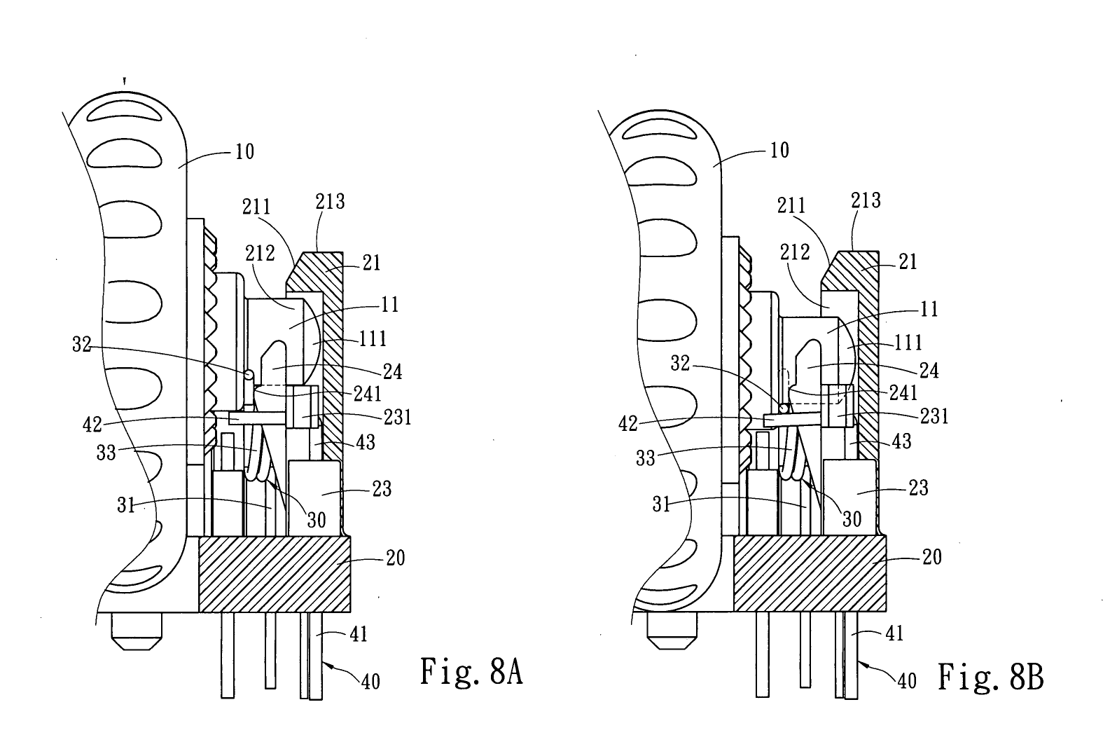

Refer to FIGS. 6, 8A and 8B, when the user depresses the wheel 10 relative to the bracing seat 20 to generate a vertical downward or upward displacement, as previously discussed for the swaying displacement, the connection terminal 30 and the conductive terminal 40 are connected to generate a depressing instruction signal. The difference is that the leftward and rightward instruction signals are generated at the same time to produce the depressing instruction signal. The resilience for bouncing the wheel 10 to its original position also is provided by the elastic coil 33 and elastic section 43, and a click sense also is generated by the click sensing dock 24 to give the user a clear indication.

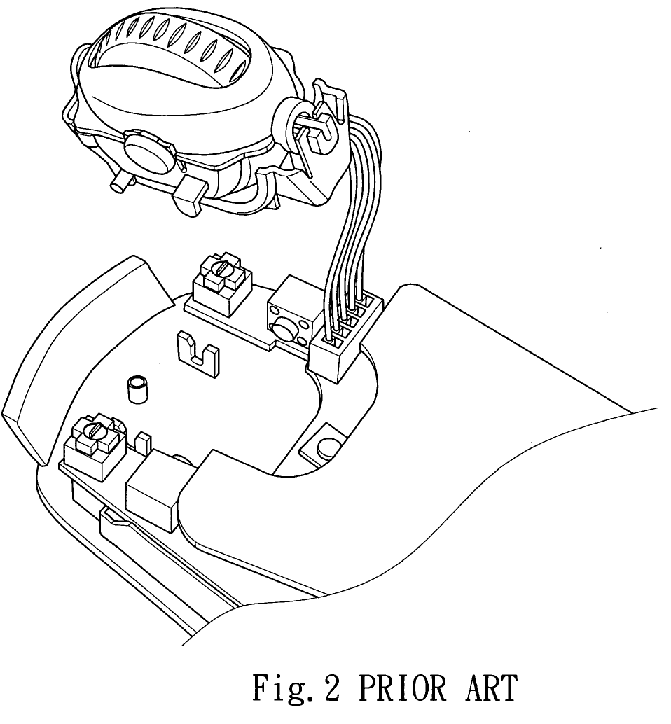

By means of the construction set forth above, the invention does not need a complicated design of a swaying seat shown in FIG. 2. The terminal design of the invention can replace the button switches located on the left side, right side and underneath the wheel 10. The design is simpler, fabrication cost may be reduced and the size is smaller than the conventional designs that adopt the swaying seat and button switches. The wheel 10 and the instruction switch design of the invention can shrink the size, and may be adopted on various types of mouse 50, keyboard 60 and other electronic devices.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wheel type mechanical instruction switch located between a wheel and a bracing seat, the wheel having an axle, the bracing seat having a holding section which has an operation space corresponding to and holding the axle such that the wheel is movable in a wheel displacement on the bracing seat, the instruction switch comprising:
a connection terminal having a first fastening end on one end to be fastened to the bracing seat and an operation end on other end extended to where the axle is located to be driven by the axle in the wheel displacement of the wheel to generate a first displacement; and
a conductive terminal having a second fastening end on one end to be fastened to the bracing seat and a conductive end on other end extended to the first displacement of the operation end such that when the wheel is moved by a force to generate the wheel displacement the axle is driven to move the operation end of the connection terminal to connect to the conductive end of the conductive terminal to generate an instruction signal.

2. The wheel type mechanical instruction switch of claim 1, wherein the holding section has a closed end on the top to inhibit the axle from escaping.

3. The wheel type mechanical instruction switch of claim 1, wherein the bracing seat has anchor sections corresponding respectively to the first fastening end of the connection terminal and the second fastening end of the conductive terminal.

4. The wheel type mechanical instruction switch of claim 1, wherein the connection terminal is bent on a middle portion thereof to form an elastic coil.

5. The wheel type mechanical instruction switch of claim 4, wherein the bracing seat has a first bracing section corresponding to and holding the elastic coil.

6. The wheel type mechanical instruction switch of claim 1, wherein the conductive terminal is bent on a middle portion thereof to form an elastic section.

7. The wheel type mechanical instruction switch of claim 6, wherein the bracing seat has a second bracing section corresponding to and holding the elastic section.

8. The wheel type mechanical instruction switch of claim 1, wherein the operation end of the connection terminal is extended beneath the axle to brace the wheel.

9. The wheel type mechanical instruction switch of claim 1, wherein the axle has an arched end.

10. The wheel type mechanical instruction switch of claim 1, wherein the holding section has a chamfered surface on an upper end.

11. The wheel type mechanical instruction switch of claim 1, wherein the bracing seat has a click sensing dock which has a boss located between the operation end of the connection terminal and the conductive end of the conductive terminal.

12. The wheel type mechanical instruction switch of claim 1, wherein the wheel displacement generated by the wheel under the force includes a rotational displacement vertical to the bracing seat, a swaying displacement tilted to the bracing seat and a up and down depressing displacement relative to the bracing seat.

13. The wheel type mechanical instruction switch of claim 12, wherein the connection terminal and the conductive terminal generate a leftward instruction signal and a rightward instruction signal during the swaying displacement of the wheel.

14. The wheel type mechanical instruction switch of claim 13, wherein a depressing instruction signal of the depressing displacement is generated when the leftward instruction signal and the rightward instruction signals are generated at the same time.

15. The wheel type mechanical instruction switch of claim 1, wherein the wheel and the instruction switch are located in a mouse.

16. The wheel type mechanical instruction switch of claim 1, wherein the wheel and the instruction switch are located in a keyboard.

17. The wheel type mechanical instruction switch of claim 1, wherein the connection terminal and the conductive terminal are located on one side of the wheel.

18. The wheel type mechanical instruction switch of claim 1, wherein the connection terminal and the conductive terminal are located on a left side and a right side of the wheel.
